(19) United States
(12) Patent Application Publication
(10) Pub. No.: US 2026/0024468 A1
(43) Pub. Date: Jan. 22, 2026

(54) PLANT MARKER AND INTEGRATED MONITOR

(71) Applicant: AP&G Co., Inc., Bayonne, NJ (US)

(72) Inventor: Edward William Dolshun, Warwick, NY (US)

(21) Appl. No.: 19/273,980

(22) Filed: Jul. 18, 2025

Related U.S. Application Data
(60) Provisional application No. 63/673,158, filed on Jul. 18, 2024.

(51) Int. Cl. G09F 3/20; A01M 3/04; G09F 3/02

(52) U.S. Cl. CPC G09F 3/206; A01M 3/04; G09F 2003/0232; G09F 2003/0233

(57) ABSTRACT

A plant marker with integrated insect monitoring capability. The plant marker includes a base layer having a rectangular segment and a pointed segment configured for soil insertion. The rectangular segment includes an upper surface coated with adhesive material for capturing insects and an underside surface formed of markable material for receiving plant identification information. A removable liner covers the adhesive material prior to use. The device enables simultaneous plant identification and pest assessment.

### RELATED APPLICATIONS

This application claims the benefit of pending U.S. Provisional Appl. No. 63/673,158 filed on Jul. 18, 2024, the contents of which are incorporated by reference herein.

### FIELD OF THE INVENTION

The invention relates to the field of insect monitoring devices, more specifically to a plant marker that has an integrated pest monitoring application.

### BACKGROUND OF THE INVENTION

Growers of various plants frequently contend with unwanted insect infestations. Accordingly, growers desire to identify the types of insects that exist in the proximity of their plants and also desire to eliminate such insects to the extent possible.

### SUMMARY OF THE INVENTION

Embodiments of the invention provide a plant marker with integrated insect monitoring capability that serves the dual function of identifying plants and capturing insects for pest assessment. The plant marker comprises a base layer formed of a semi-rigid or rigid material having a rectangular segment and a pointed segment, where the pointed segment is configured for insertion into soil or growing medium. The rectangular segment includes an upper surface coated with adhesive material configured to capture insects that contact the surface, and an underside surface formed of markable material configured to receive plant identification information such as plant type, variety, planting date, or other relevant data. A removable liner covers the adhesive material prior to use.

In operation, a user marks plant information on the underside surface, inserts the plant marker into the ground with the pointed segment, and removes the liner to expose the adhesive material. The device thus simultaneously functions as a plant identification marker and an insect monitoring trap, enabling users to correlate specific plant types with insect populations and pest pressure in their growing area while maintaining organized and plant labels.

### BRIEF DESCRIPTION OF THE FIGURES

FIG. 1 a front view of a side perspective view of plant marker, in accordance with an embodiment of the invention.

FIG. 2 is a cross-sectional view of a plant marker, in accordance with an embodiment of the invention.

FIG. 3 is a bottom view of a plant marker, in accordance with an embodiment of the invention.

FIG. 4 is a rear view of a plant marker, in accordance with an embodiment of the invention.

FIG. 5 is a side view of a plant marker, in accordance with an embodiment of the invention.

FIG. 6 is a top view of a plant marker, in accordance with an embodiment of the invention shown with the liner removed.

FIG. 7 is front view of the plant marker, in accordance with an embodiment of the invention.

### DETAILED DESCRIPTION OF THE INVENTION

Embodiments of the present invention will now be described with reference to the above-identified figures of the drawings. However, the drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

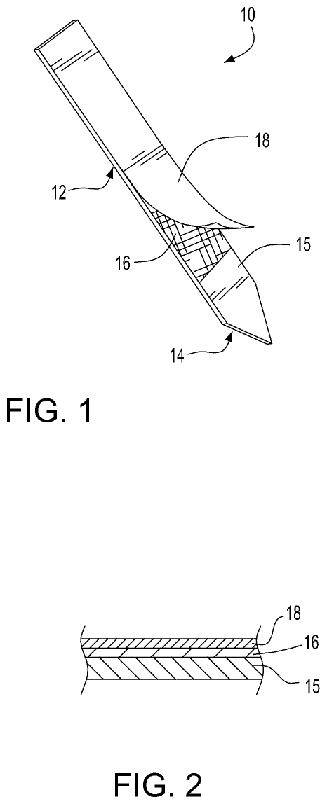

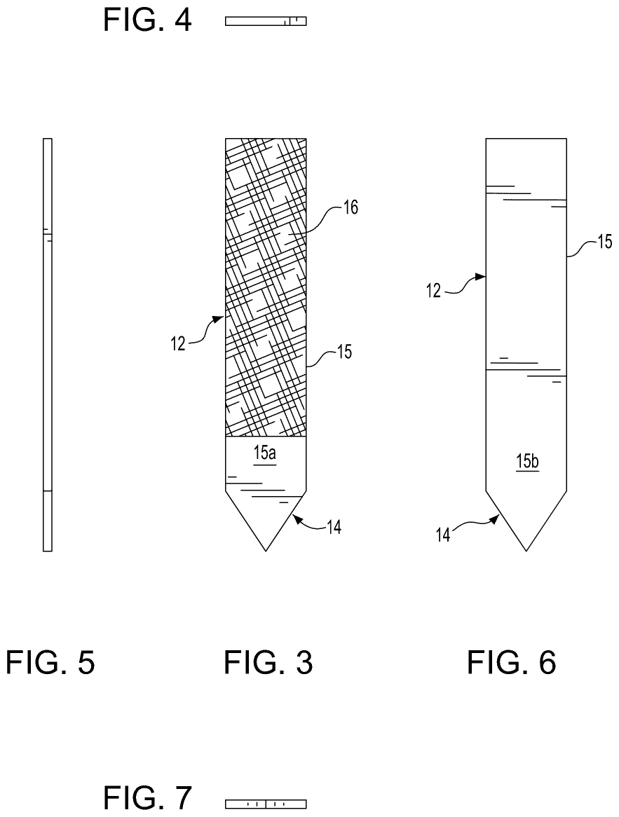

FIG. 1 shows a side perspective view of a plant marker 10. As shown, plant marker 10 is formed of a base layer 15 that has a general rectangular segment 12 and a pointed segment 14. Pointed segment 14 is configured to be inserted into the ground such that a portion of rectangular segment 12 rises above the ground and maintained substantially orthogonally to the ground.

In embodiments of the invention, base layer 15 is preferably formed of a semi rigid or rigid plastic material. Suitable plastic materials include, but are not limited to, polyethylene (PE), polypropylene (PP), polyvinyl chloride (PVC), polystyrene (PS) or the like. In alternative embodiments, the base layer 15 may be formed of composite materials, treated cardboard, coated paper products, thin metal sheets such as aluminum or galvanized steel, or biodegradable polymer materials. It will be understood that the material selection may be based on factors including environmental durability requirements and environments of intended use.

It will be understood that for outdoor agricultural applications, weather-resistant materials are preferred, while for more short-term monitoring applications, biodegradable materials may be employed. In embodiments of the invention, the base layer material is sufficiently rigid to maintain its shape when inserted into soil while still being flexible.

Base layer 15 has an upper surface 15a and an underside surface 15b. As shown, in embodiments of the invention, at least a portion of the rectangular segment 12 of upper surface 15a is coated with adhesive material 16 that is configured to adhere insects that contact the adhesive material.

In embodiments of the invention, the adhesive material is weather-resistant and maintains adhesive properties under outdoor environmental conditions including moisture, UV exposure, and temperature variations.

As shown in FIG. 1, a liner 18 or similar release paper is provided to cover the adhesive material 16 prior to use. Liner 18 is substantially sized and shaped to conform to the dimensions of adhesive material 16 to thereby cover the same. An area of liner 18 may extend past the adhesive material 16 to allow for easy grip.

In embodiments of the invention at least a portion of rectangular segment 12 of underside surface 15b is formed of markable material and is configured to receive markings by a writing implement such as, for example, by pen, marker, printer or the like. The markable material may comprise paper, cardboard, treated plastic surfaces, or specially coated substrates that provide optimal ink adhesion and legibility.

It will be understood that the underside surface 15b may be configured to accept printed labels, adhesive tags, or pre-printed information applied during manufacturing. In preferred embodiments, the markable area is of a light color such as white, yellow or similar light tone to provide sufficient contrast with common ink colors to ensure visibility.

In embodiments of the invention, in use, a user marks plant information (e.g. by writing with a pen or marker) on the underside surface 15b of the plant marker 10, then inserts the plant marker into the ground—preferably with the marked portion visible to a user. The user then peels away the liner 18 to expose the adhesive material 16. It will be understood that the liner may be removed prior to insertion into the ground. In this regard, while serving as a plant marker to provide information about plants/seeds located in a specific area—the marker also captures insects on its underside surface which provides useful insect monitoring information to a grower.

In embodiments of the invention, the marker thus functions to indicate information about a plant and also monitor insects that may be present in or around the plant. In this regard, a user may inspect the underside surface 15b of the plant marker and observe the types/quantities of insects captured on the adhesive material 16.

Embodiments of the invention include methods of monitoring insect populations using the plant marker 10 described herein. In one embodiment, a method of comparative insect monitoring comprises placing a plurality of plant markers 10 in different locations within a monitoring area, such as different sections of a garden, farm field, or urban space. Each plant marker 10 is prepared by marking relevant location information on the underside surface 15b, inserting the pointed segment 14 into the ground at the designated location, and removing the liner 18 to expose the adhesive material 16. The plant markers 10 are allowed to remain in position for a predetermined monitoring period, which may range from several hours to multiple days or weeks depending on the monitoring objectives and environmental conditions.

During the monitoring period, insects present in each location contact the exposed adhesive material 16 and become captured on the upper surface 15a of the plant marker. At the conclusion of the monitoring period, a user inspects the adhesive material on each plant marker to identify the types and quantities of captured insects. By comparing the insect capture data from different locations, the user can determine pest distribution patterns across the monitored area, identify hotspots of insect activity, and assess the relative pest pressure in different zones of their growing area or property.

In another embodiment, the invention provides a method of plant-specific pest monitoring that enables correlation of insect populations with particular plant types or varieties. This method comprises marking plant identification information on the underside surface 15b of multiple plant markers, including details such as plant species, variety, planting date, or treatment history. Each marked plant marker is positioned adjacent to its corresponding plant or plant group, with the pointed segment 14 inserted into the soil and the marked information visible to the user. The liner 18 is removed to expose the adhesive material 16, and the markers are monitored over a predetermined time period.

In embodiments of the invention, a user may systematically catalog the types and quantities of insects captured near each plant type by inspecting the adhesive material 16 on each marker 10. This data collection enables identification of plant-pest relationships, revealing which plant varieties attract specific insect species and which plants may be more or less susceptible to particular pests. Such information is valuable for planting strategies, and targeted pest management decisions.

While this invention has been described in conjunction with the embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A plant marker with integrated insect monitoring capability, comprising:
a base layer having a rectangular segment and a pointed segment, wherein the pointed segment is configured for insertion into soil or growing medium;
wherein the rectangular segment includes an upper surface and an underside surface;
wherein at least a portion of the upper surface is coated with adhesive material configured to capture insects that contact the adhesive material;
wherein at least a portion of the underside surface comprises markable material configured to receive markings for plant identification information; and
a removable liner covering the adhesive material.

2. The plant marker of claim 1, wherein the base layer is formed of a semi-rigid or rigid plastic material that is sufficiently rigid to maintain its shape when inserted into soil while being flexible enough to resist cracking under normal use conditions.

3. The plant marker of claim 1, wherein the markable material is configured to receive markings from writing implements.

4. The plant marker of claim 1, wherein the adhesive material is weather-resistant.
